(19) United States
(12) Patent Application Publication
(10) Pub. No.: US 2009/0206575 A1
(43) Pub. Date: Aug. 20, 2009

(54) Labor saving device for electric and manual bicycle

(76) Inventor: Jung-Chih Dai, Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/071,297

(22) Filed: Feb. 20, 2008

(51) Int. Cl. B62M 1/02

(52) U.S. Cl. 280/261

(57) ABSTRACT

In a labor saving device for an electric and manual bicycle, a five-way joint of the bicycle includes a first driving bushing, a ratchet at the first driving bushing and connected to a rotating axle by an elastically activated first wedge, a large gear disc, such that the motive power of a chain is transmitted to the axle of a rear wheel, and a second driving bushing is sheathed to the first driving bushing, and the center hole of the second driving bushing is installed with a ratchet in a direction opposite to the first driving bushing, and coupled with the first driving bushing by an elastically activated second wedge during a rotation, and a transmission gear is installed on a lateral side and engaged with a driving gear on a motor axle, such that when the driving power of the motor drives the bicycle to move forward, the rotating second driving bushing will drive the first driving bushing with the large gear disc to rotate the axle of the rear wheel, and the axle with the left and right cranks will remain still. On the other hand, when the crank is rotated with the axle, the first driving bushing with the large gear disc and the axle of the rear wheel is rotated and the second driving bushing with the motor axle will not be driven to rotate, so as to achieve the labor saving effect for the pedaling.

### BACKGROUND OF THE INVENTION

1. Field of the Invention

The present invention relates to a labor saving device for an electric and manual bicycle, and more particularly to a novel labor saving device for an electric and manual bicycle and the device comes with a simple-to-install and easy-to-use structure and provides a substantial labor saving effect for pedaling the bicycle.

2. Description of the Related Art

In general, a traditional electric and manual bicycle includes a motor and a transmission module (including a gear, a sprocket wheel and a chain, etc) installed onto the bicycle and provided for riders to step on the pedals for driving the bicycle to move forward, or the bicycle is driven by a motor to move forward. The motor and the transmission module are coupled with rotating components (including a front wheel axle and a rear wheel axle) of the bicycle, such that after the rotating components are driven, the riders no longer need to pedal the bicycle, but the bicycle can move forward automatically. If a rider does not want to use the motor for driving the bicycle, the rider can step on the pedals and use driving components including a pedal, a crank, a large gear disc, and a chain to resume the manual way of driving the bicycle, so as to achieve the effect of driving a bicycle electrically and manually.

With the foregoing installation and operation, the bicycle can be driven electrically and manually. Since the motor and transmission module is coupled with the rotating components of the bicycle all the time, the rider has to drive the rotating components while pedaling the bicycle to drive the motor and the transmission module to rotate, and transmission frictions are produced among the motor, the transmission module, and the rotating components of the bicycle. As a result, an extra burden is imposed on the rider's pedaling. In practical operations, the rider of a dual-purpose bicycle may find it difficult or uneasy to pedal the bicycle.

Since a general bicycle usually installs several large gear discs with different number of teeth and a derailleur at the axle of a rear wheel, the rider can adjust the derailleur according to the road conditions to achieve the best effect for the pedaling and speed of the bicycle. However, the foregoing method of using the motor and the transmission components to drive an axle of the rear wheel directly, or the front wheel cannot provide the speed changing effect, and thus the motor cannot maximize its performance.

In view of the foregoing shortcomings, the inventor of the present invention based on years of experience to conduct extensive researches and experiments, and finally developed a labor saving device for an electric and manual bicycle in accordance with the present invention to overcome the shortcomings of the prior art.

### SUMMARY OF THE INVENTION

Therefore, it is a primary objective of the present invention to provide a labor saving device for an electric and manual bicycle, wherein a five-way joint of the bicycle includes a first driving bushing, a ratchet disposed at the center of the first driving bushing and coupled to a rotating axle by an elastically activated first wedge, a large gear disc disposed on a lateral side, such that the motive power of a chain is transmitted to the axle of the rear wheel, a second driving bushing is sheathed onto the first driving bushing, and the center hole of the second driving bushing is installed with a ratchet in a direction opposite to the first driving bushing and coupled with the first driving bushing by an elastically activated second wedge during a rotation, and a transmission gear is installed on a lateral side and engaged with a driving gear on a motor axle, such that when the driving power of the motor drives the bicycle to move forward, the rotating second driving bushing will drive the first driving bushing with the large gear disc to rotate the axle of the rear wheel, and the axle with the left and right cranks will remain still. On the other hand, when the crank is rotated with the axle, the first driving bushing with the large gear disc and the axle of the rear wheel are rotated, and the second driving bushing with the motor axle will not be driven to rotate, so as to achieve the labor saving effect for pedaling the bicycle.

Another objective of the invention is to provide a labor saving device for an electric and manual bicycle, wherein a rotating force of the five-way joint and the motor is transmitted to the first driving bushing through the large gear. After several large gear discs with a different number of teeth are installed to the first driving bushing, the chain ring is installed at a derailleur on the axle of the rear wheel, and the bicycle driven by the motor or manual pedaling can achieve the expected speed changing effect.

### BRIEF DESCRIPTION OF THE DRAWINGS

FIG. 1 is a cross-sectional view of a preferred embodiment of the present invention;

FIG. 2 is a front sectional view of a preferred embodiment of the present invention;

FIG. 3 is a schematic view of an axle, a first driving bushing, a second driving bushing, a first wedge and a second wedge in accordance with a preferred embodiment of the present invention;

FIG. 4 is a front view of a bicycle driven by a motor in accordance with a preferred embodiment of the present invention; and

FIG. 5 is a front view of riding a bicycle by pedaling in accordance with a preferred embodiment of the present invention.

### DETAILED DESCRIPTION OF THE PREFERRED EMBODIMENTS

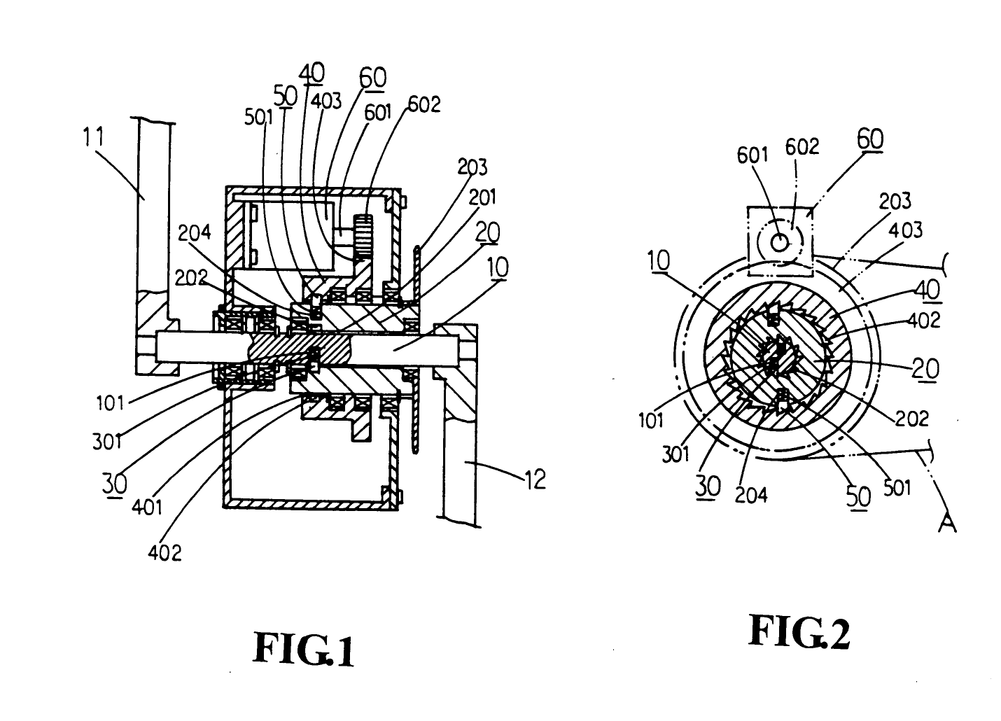

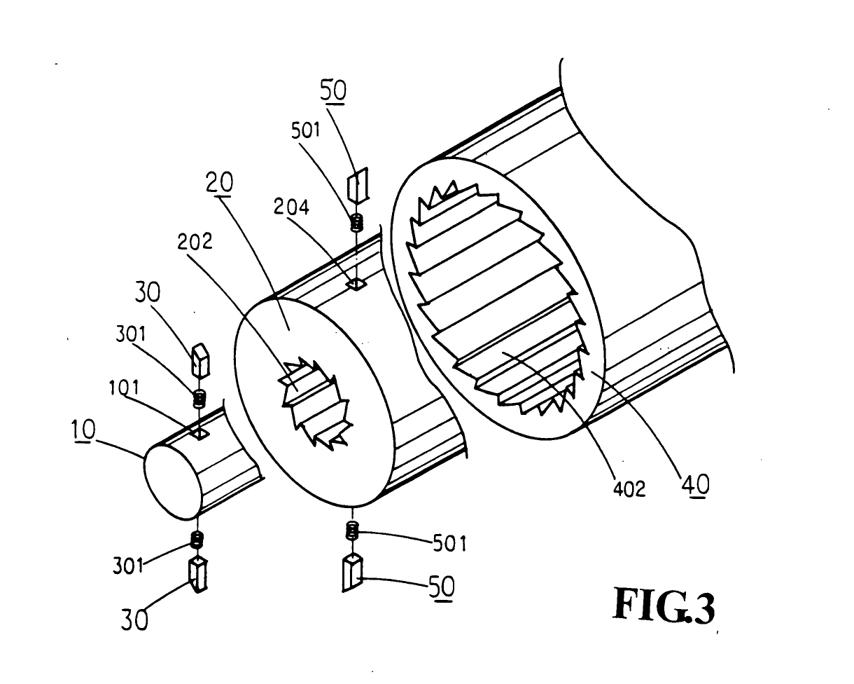

Referring to FIGS. 1 to 3 for a labor saving device for an electric and manual bicycle, the bicycle comprises: a five-way joint 10, having at least one positioning hole 101 disposed at an appropriate position on the periphery, left and right cranks 11. 12 disposed on both ends respectively, and a pedal (not shown in the figure) installed separately at the left and right cranks 11, 12; a first driving bushing 20, pivotally and freely coupled to the axle 10, and having a plurality of ratchets 202 installed at appropriate positions around the center hole 201, a large gear disc 203 disposed on a lateral side, and at least one positioning hole 204 disposed at an appropriate position on the periphery and at an axle of the rear wheel (not shown in the figure) by means of the transmission power of a chain A; at least one first wedge 30, movably installed into a positioning hole 101 of the axle 10 and corresponding to an elastic element 301, such that the first wedge 30 corresponds to the ratchet 202 of the first driving bushing 20, and its external end is exposed slantingly in the same direction as the ratchet 202 of the first driving bushing 20, and cannot be elastically latched into the corresponding ratchet 202 when the axle 10 is rotated; a second driving bushing 40, pivotally coupled to the periphery of the first driving bushing 20, and having a plurality of ratchets 402 disposed at appropriate positions around a center hole 401 and installed in a direction opposite to the ratchet 202 of the first driving bushing 20, and a transmission gear 403 disposed on a lateral side; at least one second wedge 50, corresponding to an elastic element 501 and movably installed into a positioning hole 204 disposed on the periphery of the first driving bushing 20, and precisely aligned with the ratchet 402 of the second driving bushing 40, and its external end is exposed slantingly in the same direction as the ratchet 402 of the second driving bushing 40 and latched elastically into the corresponding ratchet 402 when the second driving bushing 40 is rotated; a motor 60, installed at a position proximate to the five-way joint of the bicycle, and having a driving gear 602 disposed at an external end of the axle 601 and engaged with a transmission gear 403 of the second driving bushing 40.

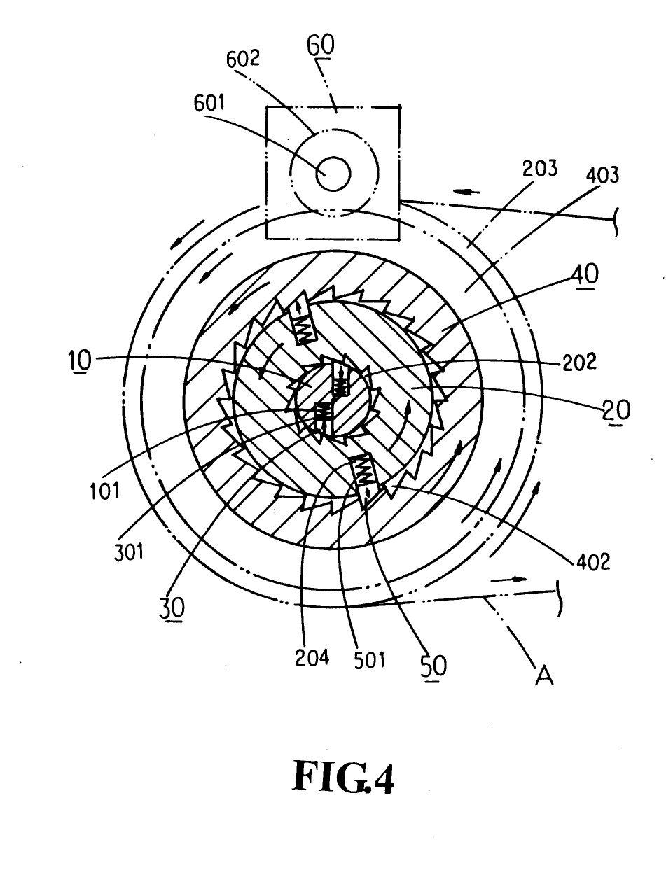

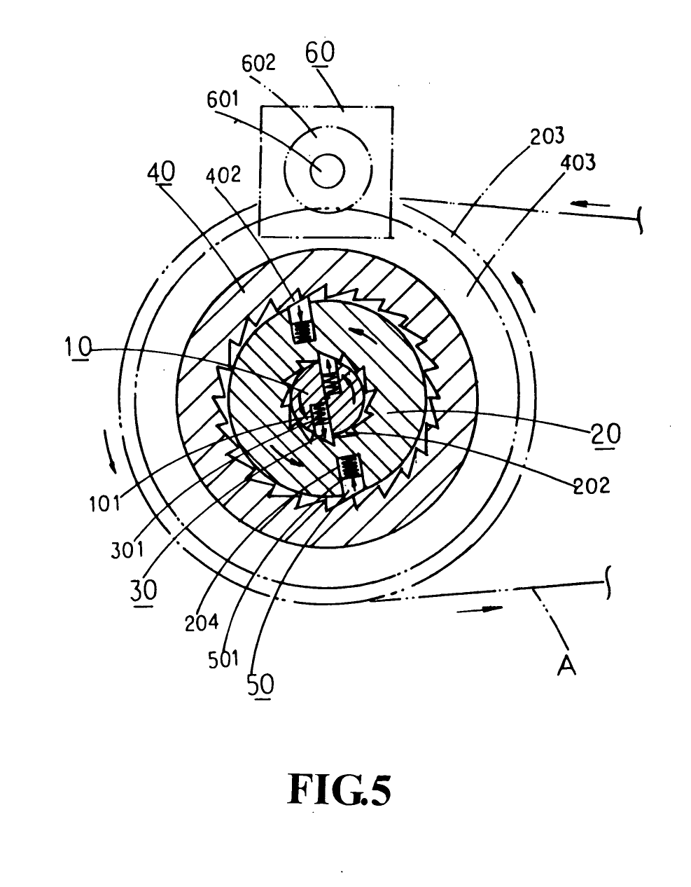

In the foregoing structure of the invention as shown in FIG. 4, when the motor is turned, and the bicycle is driven by the motive power of the motor to move forward, the driving gear 602 on the motor axle 601 drives the engaged transmission gear 403, such that the second driving bushing 40 integrated with the transmission gear 403 is rotated accordingly. In the meantime, the second wedge 50 installed at the first driving bushing 20 is rotated at the second driving bushing 40, and the second wedge 50 is latched to the ratchets 402 around the center hole 401, and the, first driving bushing 20 will drive the driven second driving bushing 40 to rotate, such that the large gear disc 203 installed on a lateral side of the first driving bushing 20 can be rotated accordingly, and the chain A around the large gear disc 203 can drive the axle of the rear wheel to move the bicycle. Since the aslant direction of the ratchet 202 around the center hole of the first driving bushing 20 is opposite to the direction of the ratchet 402 of the second driving bushing 40, therefore if the second wedge 30 installed at the axle 10 is rotated at the axle 10, the second wedge 30 will be latched to the ratchet 202 of the first driving bushing 20. If the first driving bushing 20 together with the large gear disc 203 are rotated and driven by the motor 60, the elastically activated first wedge 30 cannot be latched naturally with the ratchet 202, and thus the axle 10 will not be rotated accordingly. The cranks 11, 12 installed on both ends of the axle 10 together with the pedals installed at the cranks 11, 12 will not be rotated by the motor 60 or will not affect the pedaling operation.

In FIG. 5, if a rider steps on the pedals of the bicycle to drive the bicycle to move forward, and the left and right cranks 11, 12 together with the axle 10 are rotated, the first wedge 30 installed at the axle 10 can be rotated accordingly and latched to the ratchet 202 of the first driving bushing 20, and the first driving bushing 20 together with the large gear disc 203 installed on a lateral side are rotated together, so that the chain A around the large gear disc 203 can be used to achieve the effect of driving the axle of the rear wheel to move the bicycle. Since the aslant ratchet 402 around the center hole of the second driving bushing 40 is in an opposite direction with the ratchet 202 of the first driving bushing 20, the second wedge 50 installed on the first driving bushing 20 is rotated with the first driving bushing 20 and cannot be latched to the ratchet 402 of the second driving bushing 40. When the first driving bushing 20 together with the large gear disc 203 are driven by the axle 10 to rotate, the second driving bushing 40 will not be rotated accordingly, and the transmission gear 403 on a lateral side of the second driving bushing 40 will be engaged with the motor axle 601 of the driving gear 602 and cannot be rotated accordingly. Therefore, the pedaling force is provided for driving the large gear disc 203 only, but not for overcoming the transmission friction or resistance between the motor axle 601 with the driving gear 602 and the second driving bushing 40, so as to achieve the labor saving effect.

Since the driving force produced by the motor 60 and the five-way joint 10 is transmitted to the large gear disc 203 through the first driving bushing 20 to meet the requirements of the actual application. Several large gear discs 203 with a different number of teeth can be installed at the first driving bushing 20, such that if a derailleur (not shown in the figure) is installed at the axle of the rear wheel of the bicycle, the driving force produced by the motor 60 or manual pedaling of the axle 10 is transmitted through the same chain A to achieve the speed changing effect. The invention can achieve the labor saving effect according to the road conditions, lower the burden of the motor, and improve the life expectancy.

What is claimed is:

1. A labor saving device for an electric and manual bicycle, comprising a motor installed adjacent to a five-way joint of the bicycle, and an axle of the motor installing a driving gear; a pedal, installed to the five-way joint of the bicycle, and having left and right cranks installed at appropriate positions on both ends of the pedal, characterized in that the axle has at least one positioning hole disposed on an appropriate position of the periphery of the axle, and a first driving bushing pivotally coupled thereon; a plurality of ratchets are disposed around a center hole of the first driving bushing, and a large gear disc is installed on a lateral side, and at least one positioning hole is disposed at an appropriate position; an elastic element and a first wedge of the axle are movably installed at positions on the periphery of the positioning hole, such that the first wedge is exposed and corresponsive to the ratchet of the first driving bushing, and an external end of the first wedge is aslant in the same direction as the ratchet of the first driving bushing and elastically latched into the corresponding ratchet when the axle is rotated; a second driving bushing pivotally coupled to the periphery of the first driving bushing and at an appropriate position of the center hole of the second driving bushing and having a plurality of ratchets installed in a direction opposite to the ratchets of the first driving bushing, and a transmission gear disposed on a lateral side and engaged precisely with the driving gear on the motor axle; an elastic element and a second wedge, movably installed on the periphery of the first driving bushing and at a position of the positioning hole, such that the second wedge is exposed and corresponsive to the ratchet of the second driving bushing, and an external end of the second wedge is disposed in an aslant direction of the ratchet of the second driving bushing, and elastically latched into the corresponding ratchet when the second driving bushing is rotated; so as to constitute the labor saving device for the electric and manual bicycle.

2. The labor saving device for an electric and manual bicycle of claim 1, wherein a plurality of large gear discs with different numbers of teeth are installed on a lateral side of the first driving bushing.
